(19) United States
(12) Patent Application Publication
(10) Pub. No.: US 2007/0273613 A1
(43) Pub. Date: Nov. 29, 2007

(54) LIGHT CIRCUIT AND ELECTRONIC BOOK EMPLOYING SAME

(75) Inventors: Xu-Chen Mu, Shenzhen City (CN); Shin-Hong Chung, Shenzhen City (CN); Han-Che Wang, Shenzhen City (CN); Kuan-Hong Hsieh, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/752,920

(22) Filed: May 23, 2007

(30) Foreign Application Priority Data
May 24, 2006 (CN) 200610060764.5

(51) Int. Cl. G09G 3/16

(52) U.S. Cl. 345/48

(57) ABSTRACT

An exemplary light circuit includes a light unit (7) that includes a plurality of light branches (L1, L2 . . . and Ln) connected in parallel; an ambient light detector (9) for detecting an ambient luminance; an ambient light switch (101) for enabling/disenabling the ambient light detector; a control unit (3) for producing PWM waves with a particular duty cycle according to the detected ambient luminance; and a switching circuit (6) for alternatively switching on and off the light unit according to the PWM waves. An exemplary electronic book (1) configured with the lighting circuit is also provided.

### CROSS REFERENCE TO RELATED APPLICATION

This application is related to a pending application entitled “LIGHT CIRCUIT”, filed around the same time that this application is filed. The entire contents of the related application are incorporated herein by reference.

### BACKGROUND OF THE INVENTION

1. Technical Field

The present invention relates to light circuits, and more particularly to a light circuit used for lighting an electronic device such as an electronic book.

2. Related Art

Many electronic devices typically employ LEDs (light emitting diodes) to light displays and enable users to view the displays clearly under any environment. It can be difficult to control the luminance of the LEDs of certain electronic devices. For example, even when the display of an electronic device can be easily viewed without the need for illumination by the LEDs, the LEDs may still be lit and unnecessarily consume power.

Electronic books that utilize E-papers as displays have no built-in backlighting modules, and are thus power-saving. However, the contents of the display of this type of electronic book are not visible in the dark or under weak ambient light conditions. This may cause much inconvenience for users.

Therefore, there is a need for providing a light circuit and electronic book employing the light circuit which can solve at least the problems described above.

### SUMMARY

A light circuit is provided. In a preferred embodiment, the light circuit includes a light unit that includes a plurality of light branches connected in parallel, each light branch including an electroluminescent body; an ambient light detector for detecting an ambient luminance; an ambient light switch for enabling/disenabling the ambient light detector; a control unit for producing PWM waves with a particular duty cycle according to the detected ambient luminance; and a switching circuit for alternatively switching on and off the light unit according to the PWM waves.

An electronic book is also provided. In a preferred embodiment, the electronic book includes a light circuit that is provided for lighting a display area of the electronic book. The light circuit includes a light unit that includes a plurality of light branches connected in parallel, each light branch including an electroluminescent body; an ambient light detector for detecting an ambient luminance; an ambient light switch for enabling/disenabling the ambient light detector; a control unit for producing PWM waves with a particular duty cycle according to the detected ambient luminance; and a switching circuit for alternatively switching on and off the light unit according to the PWM waves.

Other novel features and advantages will be drawn from the following detailed description with reference to the attached drawings, in which:

### BRIEF DESCRIPTION OF THE DRAWINGS

FIG. 1 is a simplified, isometric, partly cutaway view of an electronic book, the electronic book being an exemplary application of a light circuit of a preferred embodiment of the present invention;

FIG. 2 is a block diagram of the light circuit in accordance with the preferred embodiment of the present invention;

FIG. 3 is an enlarged view showing details relating to an ambient light switch and a lighting switch of the light circuit of FIG. 2;

FIG. 4 is a block diagram showing further details of a control unit of the light circuit of FIG. 2; and

FIG. 5 is a circuit diagram relating to certain parts of the light circuit of FIG. 2.

### DETAILED DESCRIPTION OF THE EMBODIMENTS

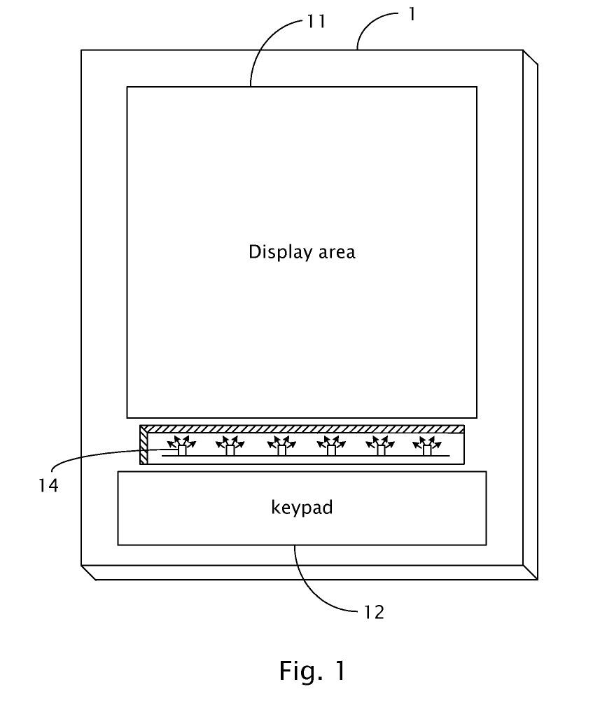

Referring to FIG. 1, this shows an electronic book 1, which is provided as an exemplary application of a light circuit of a preferred embodiment of the present invention. The electronic book 1 includes a display area 11 and a keypad 12. The light circuit is able to provide illumination for the display area 11. In particular, a plurality of electroluminescent bodies 14 of the light circuit surrounds the display area 11 and lights the display area 11. Light from the electroluminescent bodies 14 provides better viewing conditions when the electronic book 1 is in an environment with insufficient ambient light.

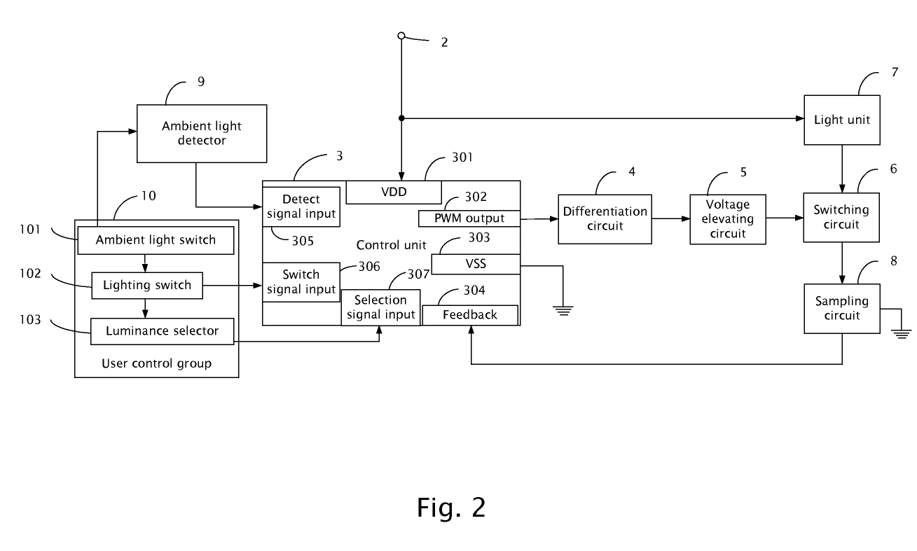

Referring also to FIG. 2, the light circuit includes a control unit 3, a light unit 7, and an ambient light detector 9. The light unit 7 employs the electroluminescent bodies 14 so as to light the display area 11 of the electronic book 1. The control unit 3 and the light unit 7 receive power from a direct current (DC) power source 2. The control unit 3 includes a VDD pin 301 connected to the DC power source 2, a PWM (pulse width modulation) output port 302 to output PWM waves that control a luminance of the electroluminescent bodies 14, a VSS pin 303 that is grounded, and a feedback port 304 for receiving feedback information of a current luminance of the electroluminescent bodies 14 from a sampling circuit 8. The ambient light detector 9 is used to detect an ambient luminance of the environment where the electronic book 1 is located. The control unit 3 further includes a detect signal input port 305, a switch signal input port 306, and a selection signal input port 307. The detect signal input port 305 is provided for receiving light detection signals from the ambient light detector 9. The switch signal input port 306 is provided for receiving switch signals from a lighting switch 102, which is provided to enable/disable the light circuit. The selection signal input port 307 is provided for receiving selection signals from a luminance selector 103, which is provided to manually select a luminance value of the light circuit.

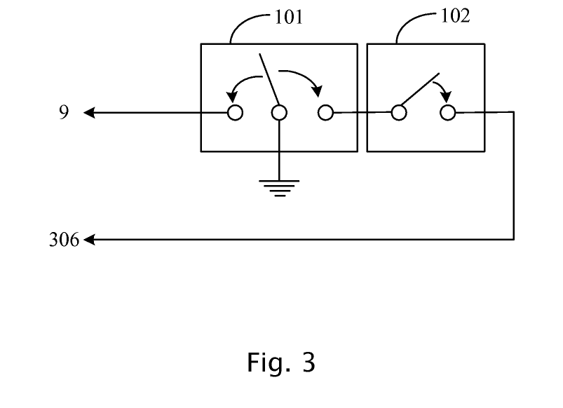

The lighting switch 102 and the luminance selector 103 are included in a user control group 10. The user control group 10 also includes an ambient light switch 101, which is provided to enable/disable the ambient light detector 9. The user control group 10 is configured at the keypad 12 of the electronic book 1. As shown in FIG. 2, the ambient light switch 101 determines operation of the lighting switch 102. The relationship between the ambient light switch 101 and the lighting switch 102 is illustrated in more detail in FIG. 3. In particular, the ambient light switch 101 is a changeover switch, which connects either the ambient light detector 9 or the lighting switch 102 to ground, according to operational inputs. The lighting switch 102 is a simple on/off switch, and is enabled when it is grounded by the ambient light switch 101. In alternative embodiments, the ambient light switch 101 and the lighting switch 102 can be configured so that operation of the ambient light switch 101 is determined by the lighting switch 102. For example, the lighting switch 102 can be a changeover switch, and the ambient light switch 101 be a simple on-off switch.

The lighting switch 102 restricts operation of the luminance selector 103. That is, the luminance selector 103 is enabled only after the light circuit is turned on by the lighting switch 102.

The PWM output port 302 of the control unit 3 outputs the PWM waves to a differentiation circuit 4. The differentiation circuit 4 differentiates the PWM waves to produce differentiated waves. The differentiated waves are input to a voltage elevating circuit 5. The voltage elevating circuit 5 elevates a voltage of the differentiated waves, which are then used to control a switching circuit 6. The switching circuit 6 switches on according to the differentiated waves, thereby forming an electrical conduction path from the light unit 7 to ground via the sampling circuit 8. Thus the electroluminescent bodies 14 of the light unit 7 are turned on.

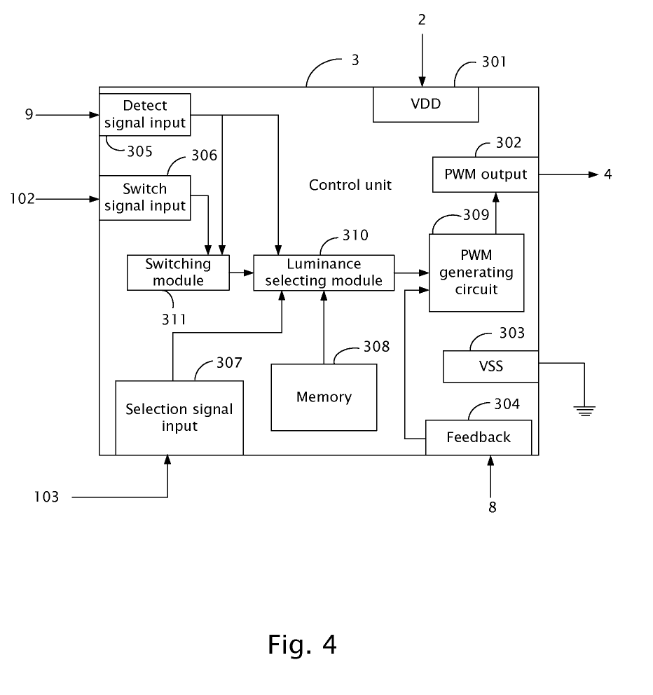

Referring also to FIG. 4, the control unit 3 further includes a memory 308, a switching module 311, a luminance selecting module 310, and a PWM generating circuit 309. The switching module 311 receives the light detection signals via the detect signal input port 305 or the switch signals via the switch signal input port 306, and enables the luminance selecting module 310 accordingly. The luminance selecting module 310 receives the light detection signals via the detect signal input port 305 or the selection signals via the selection signal input port 307. The light detection signals include ambient luminance values, and the selection signals include selected luminance values for the light circuit. Accordingly, the luminance selecting module 310 controls the PWM generating circuit 309 to generate PWM waves with suitable duty cycles.

More particularly, the memory 308 stores a plurality of preset luminance values and a plurality of preset ambient luminance intervals, each preset ambient luminance interval corresponding to a respective preset luminance value. When the luminance selecting module 310 receives an ambient luminance value, the luminance selecting module 310 first determines a particular preset ambient luminance interval that the received ambient luminance value falls within. The luminance selecting module 310 then determines a particular preset luminance value according to the particular preset ambient luminance interval obtained. When the luminance selecting module 310 receives a selected luminance value, the luminance selecting module 310 directly determines a corresponding particular preset luminance value. In either case, the particular preset luminance value is then transmitted to the PWM generating circuit 309. Generally, one of various possible preset luminance values is specified as a default luminance value. If the luminance selecting module 310 does not receive an ambient luminance value or a selected luminance value within a preset period of time after being enabled by the switching module 311, the luminance selecting module 310 selects the default luminance value as the particular preset luminance value.

The PWM generating circuit 309 receives feedback information on a current luminance of the electroluminescent bodies 14 from the feedback port 304, compares the feedback information with the particular preset luminance value that the luminance selecting module 310 transmits, and controls duty cycles of the PWM waves it produces according to a result of the comparison. The PWM waves are then used to switch on and off the switching circuit 6 alternately, thereby controlling the electroluminescent bodies 14 to light up in accordance with the particular preset luminance value. Generally, the switching circuit 6 operates at a very high switching frequency, and the light unit 7 is turned on and turned off at a frequency imperceptible to the human eye. What a user can observe is a change in luminance of the light unit 7.

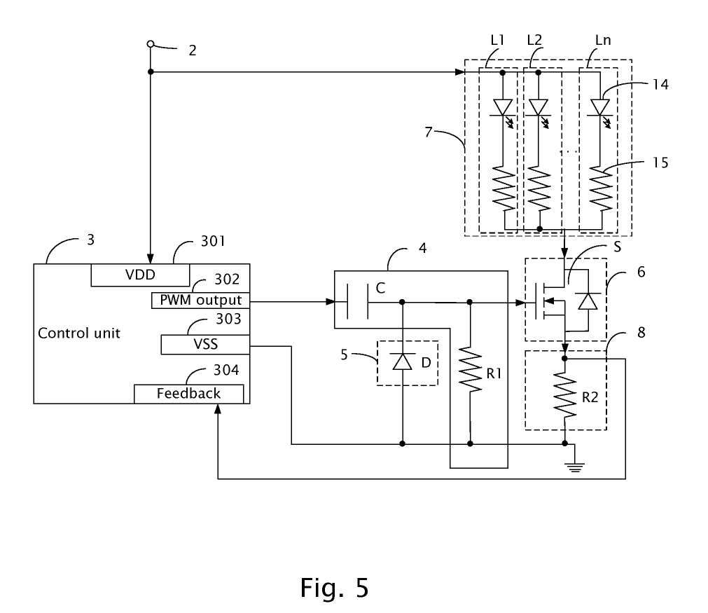

Referring also to FIG. 5, the light unit 7 includes a plurality of light branches L1, L2 . . . and Ln that are connected in parallel between the DC power source 2 and the switching circuit 6. Each light branch includes an electroluminescent body 14 and a resistance component 15 connected in series with the electroluminescent body 14. In FIG. 5, the electroluminescent bodies 14 are light emitting diodes (LEDs), and the resistance components 15 are employed to achieve resistance balances between the light branches L1, L2 . . . and Ln. The switching circuit 6 includes a MOSFET (Metal Oxide Semiconductor Field Effect Transistor) S. The MOSFET S includes a gate, a source, and a drain. The gate is controlled by the differentiated PWM waves received from the voltage elevating circuit 5, the drain is connected with the light unit 7, and the source is connected with the sampling circuit 8. The sampling circuit 8 is a resistor R2 connected between the source of the switching circuit 6 and ground. The feedback information is outputted to the feedback port 304 of the control unit 3 from a node of the sampling circuit 8 that is located between the resistor R2 and the switching circuit 6. The differentiation circuit 4 is an RC (resistor/capacitor) differentiation circuit, and includes a resistor R1 and a capacitor C. An RC differentiation circuit only provides output when there are changes in the voltage input thereto. The voltage elevating circuit 5 is a diode D inversely connected between the gate of the switching circuit 6 and ground.

The PWM waves from the PWM output port 302 of the control unit 3 are differentiated by the differentiation circuit 4 into differentiated waves. The differentiated waves are elevated in voltage by the voltage elevating circuit 5 before being used to control the operation of the switching circuit 6. If the control unit 3 malfunctions and begins to output 100% duty cycle PWM waves uninterruptedly (i.e., a constant high-level voltage), the differentiating circuit 4 provides no output. Therefore the electroluminescent bodies 14 are turned off quickly, and the user is alerted of the malfunction. Thereby, unnecessary power consumption is avoided. Further, the electroluminescent bodies 14 are protected from being damaged or destroyed by the malfunction of the control unit 3.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light circuit comprising:
a light unit comprising a plurality of light branches connected in parallel, each light branch comprising an electroluminescent body;
an ambient light detector configured for detecting an ambient luminance;
an ambient light switch configured for enabling and disabling the ambient light detector;
a control unit configured for producing pulse width modulation (PWM) waves with a particular duty cycle according to the detected ambient luminance; and
a switching circuit configured for alternately switching on and off the light unit according to the PWM waves.

2. The light circuit as claimed in claim 1, further comprising a memory configured for storing a plurality of preset luminance values and a plurality of ambient luminance intervals, each ambient luminance interval corresponding to a respective one of the preset luminance values.

3. The light circuit as claimed in claim 2, wherein the control unit comprises a luminance selecting module and a PWM generating circuit, the luminance selecting module is configured for determining a particular preset luminance value according to a particular luminance interval that the detected ambient luminance falls within, and the PWM generating circuit is configured for generating PWM waves with the particular duty cycle according to the particular preset luminance value.

4. The light circuit as claimed in claim 3, wherein the control unit further comprises a switching module configured for enabling the luminance selecting module according to the detected ambient luminance.

5. The light circuit as claimed in claim 1, further comprising a sampling circuit configured for providing feedback information of a current luminance of the light unit to the control unit.

6. The light circuit as claimed in claim 5, wherein the control unit produces the pulse width modulation (PWM) waves with the particular duty cycle further according to the feedback information from the sampling circuit.

7. The light circuit as claimed in claim 1, wherein each light branch further comprises a resistance component which is connected in series with the electroluminescent body, and the resistance components of the light branches are configured for achieving resistance balance between the light branches.

8. An electronic book, comprising:
a display area for displaying information;
a keypad; and
a light circuit arranged for lighting the display area, the light circuit comprising:
a light unit comprising a plurality of light branches, each light branch comprising an electroluminescent body;
an ambient light detector configured for detecting an ambient luminance;
an ambient light switch configured for enabling and disenabling the ambient light detector;
a control unit configured for producing pulse width modulation (PWM) waves with a particular duty cycle according to the detected ambient luminance; and
a switching circuit for alternately switching on and off the light unit according to the PWM waves.

9. The electronic book as claimed in claim 8, further comprising a memory configured for storing a plurality of preset luminance values and a plurality of ambient luminance intervals, each ambient luminance interval corresponding to a respective one of the preset luminance values.

10. The electronic book as claimed in claim 9, wherein the control unit comprises a luminance selecting module and a PWM generating circuit, the luminance selecting module is configured for determining a particular preset luminance value according to a particular luminance interval that the detected ambient luminance falls within, and the PWM generating circuit is configured for generating PWM waves with the particular duty cycle according to the particular preset luminance value.

11. The electronic book as claimed in claim 10, wherein the control unit further comprises a switching module configured for enabling the luminance selecting module according to the detected ambient luminance.

12. The electronic book as claimed in claim 8, wherein the ambient light switch is located at the keypad.

13. The electronic book as claimed in claim 8, wherein each light branch further comprises a resistance component which is connected in series with the electroluminescent body, and the resistance components of the light branches are configured for achieving resistance balance between the light branches.

14. The electronic book as claimed in claim 8, wherein the electroluminescent bodies are arranged at a periphery of the display area.
